(19) United States
(12) Patent Application Publication
(10) Pub. No.: US 2015/0170160 A1
(43) Pub. Date: Jun. 18, 2015

(54) BUSINESS CATEGORY CLASSIFICATION

(71) Applicant: Google Inc., Mountain View, CA (US)

(72) Inventor: Stefan BURKHARDT, Bach (CH)

(21) Appl. No.: 13/926,583

(22) Filed: Jun. 25, 2013

Related U.S. Application Data
(60) Provisional application No. 61/717,581, filed on Oct. 23, 2012.

(51) Int. Cl. G06Q 30/02

(52) U.S. Cl. CPC G06Q 30/0201

(57) ABSTRACT

A machine-implemented method for identifying, from a plurality of business related documents, one or more documents related to a business entity, the method comprising the steps of calculating a term frequency for each of a plurality of category phrases, wherein each of the plurality of category phrases is associated with at least one of a plurality of business categories, calculating a document frequency and a global frequency for each of the plurality of category phrases, and calculating a relevance score for each of the plurality of business categories. In some aspects, the method further comprises the step of associating one or more of the plurality of business categories with the business entity based on the relevance score calculated for each of the one or more of the plurality of business categories. Systems and machine-readable media are also provided.

### CROSS-REFERENCE TO RELATED APPLICATIONS

The present application claims the benefit of priority under 35 U.S.C. §119 from U.S. Provisional Patent Application Ser. No. 61/717,581, filed on Oct. 23, 2012, the disclosure of which is hereby incorporated by reference in its entirety for all purposes.

### BACKGROUND

The subject disclosure relates generally to a system and method for associating business entities with one or more business categories based on a relevance score.

With the growing prevalence of electronic commerce, an increasing amount of business related information is readily available online in the form of web pages, business reviews, etc. For some businesses, listing and business category information is accessible via online directories.

### SUMMARY

The disclosed subject matter relates to a machine-implemented method for assigning a category to a business entity, the method comprising steps for identifying, from a plurality of business related documents, one or more documents related to a business entity, calculating a term frequency for each of a plurality of category phrases, wherein each of the plurality of category phrases is associated with at least one of a plurality of business categories, and wherein the term frequency for each of the category phrases is based on a number of occurrences of the category phrase within the one or more identified documents, calculating a document frequency for each of the plurality of category phrases based on a number of the one or more documents that include the category phrase and calculating a global frequency for each of the plurality of category phrases, wherein the global frequency for each of the category phrases is based on a number of occurrences of the category phrase within the plurality of business related documents. In some aspects, the method further comprises steps for calculating a relevance score for each of the plurality of business categories, wherein the relevance score for each business category is based on the term frequency, the document frequency and the global frequency for each of the category phrases associated with that business category and associating one or more of the plurality of business categories with the business entity based on the relevance score calculated for each of the one or more of the plurality of business categories.

The disclosed subject matter also relates to a system for assigning a category to a business entity, the system comprising one or more processors and a machine-readable medium comprising instructions stored therein, which when executed by the processors, cause the processors to perform operations comprising steps for identifying, from a plurality of business related documents, one or more documents related to a business entity, calculating a term frequency for each of a plurality of category phrases, wherein each of the plurality of category phrases is associated with at least one of a plurality of business categories, wherein the term frequency for each of the category phrases is based on a number of occurrences of the category phrase within the one or more identified documents and calculating a global frequency for each of the plurality of category phrases, wherein the global frequency for each of the category phrases is based on a number of occurrences of the category phrase within the plurality of business related documents. In some aspects the system is also configured to perform steps for calculating a document frequency for each of the plurality of category phrases based on a number of the one or more documents that include the category phrase, calculating a relevance score for each of the plurality of business categories, wherein the relevance score for each business category is based on the term frequency, the global frequency and the document frequency for each of the category phrases associated with that business category and associating one or more of the plurality of business categories with the business entity based on the relevance score calculated for each of the one or more of the plurality of business categories.

The disclosed subject matter also relates to a machine-readable medium comprising instructions stored therein, which when executed by a machine, causes the machine to perform operations that comprise identifying, from a plurality of business related documents, one or more documents related to a business entity, calculating a term frequency for each of a plurality of category phrases, wherein each of the plurality of category phrases is associated with at least one of a plurality of business categories, wherein the term frequency for each of the category phrases is based on a number of occurrences of the category phrase within the one or more identified documents. In some aspects, the operations further comprise steps for calculating a global frequency for each of the plurality of category phrases, wherein the global frequency for each of the category phrases is based on a number of occurrences of the category phrase within the plurality of business related documents, calculating a document frequency for each of the plurality of category phrases based on a number of the one or more documents that include the category phrase and calculating a web reference count based on a total number of the one or more documents related to the business entity. In certain implementations, the machine-readable medium may also comprise instructions for performing operations for calculating a relevance score for each of the plurality of business categories, wherein the relevance score for each business category is based on the term frequency, the global frequency, the document frequency and the web reference count and associating one or more of the plurality of business categories with the business entity based on the relevance score calculated for each of the one or more of the plurality of business categories.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative, and not restrictive in nature.

### BRIEF DESCRIPTION OF THE DRAWINGS

Certain features of the subject technology are set forth in the appended claims. However, for the purpose of explanation, several embodiments of the subject technology are set forth in the following figures.

FIG. 1 illustrates a flow diagram of an example method for associating one or more business categories with a business entity.

FIG. 2 conceptually illustrates an example of the relationship between a business category and a relevance score, according to some aspects of the subject disclosure.

FIG. 3 conceptually illustrates a system for implementing some aspects of the subject disclosure.

FIG. 4 illustrates an example network that can be used for implementing certain aspects of the subject disclosure.

FIG. 5 conceptually illustrates an electronic system with which some aspects of the subject disclosure can be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent to those skilled in the art that the subject technology is not limited to the specific details set forth herein and can be practiced without these specific details. In some instances, well-known structures and components are shown in block diagram form in order to avoid obscuring the concepts of the subject technology.

An ever increasing amount of business listing information is available online. Business listing information can typically be found in a variety of electronic documents, such as business web sites, advertisements and/or online business reviews, etc. Typical forms of business listing information include, but are not limited to, business names, web addresses, location information, phone numbers, business hours information, descriptions of goods and services etc. Although listing information is typically available from a variety of online sources, available information often lacks any type of standardized category identifier that would make it possible to easily determine the relevant business category classification. The ability to differentiate one or more business entities based on a business category classification could be useful in a number of ways, such as by providing improved search results and/or business location results on a map, etc.

This subject disclosure provides a method and system for associating business entities with one or more business categories. More specifically, the subject disclosure provides a method by which one or more n-grams (i.e., “category phrases”) associated with one or more business categories can be used to determine a relevance score for one or more business categories with respect to a business entity. In some aspects, the association between one or more business categories and a particular business entity will be made only if the relevance score for the categories exceeds a threshold.

One or more of a plurality of category phrases is associated with a given business category. For example, the category phrases “pepperoni”, “delivery” and “NY Style” could be associated with the “Pizza Restaurant” business category. It is understood that some (or all) category phrases associated with a particular business category can also be associated with one or more other business categories. By way of example, the business category “Chinese Restaurant” could also be associated with the category phrase “delivery,” as is the “Pizza Restaurant” category in the example above.

The relevance score calculated for any particular business category is based on various measurements of the occurrence of the category phrases (associated with the particular business category) in a plurality of business related documents. Business related documents can comprise virtually any electronic document or electronic information item containing information related to one or more business entities. By way of example, business related documents could include web pages mentioning one or more business entities, anchor text from hyperlinks to one or more business websites, web documents, advertisements and/or feeds containing business reviews, etc.

The relevance scores are calculated for one or more business categories with respect to a particular business entity and provide measure of the relevance between a given business classification and the business entity. Although the relevance score for a given business category can be represented in essentially any numerical form (e.g., an integer or floating point value, etc.), in some examples the relevance score may be represented by a multi-dimensional number set (e.g., a vector or matrix). In some implementations, the relevance score for a business category could be represented by a vector of length N, where N corresponds to an integer value equal to the number of category phrases associated with the business category. For example, in the “Pizza Restaurant” example given above (having three category phrases), the relevance score for the “Restaurant Category” could be a vector of length three (e.g., N=3).

It is understood that the relationship between a particular category phrase and the information contained within the corpus of available business related documents can be measured in a multitude of ways. For example, multiple quantities related to a particular category phrase can be used for the relevance score calculation. By way of example, for any category phrase a term frequency, global frequency and document frequency can be calculated. Additionally, the web reference count for a particular business entity may be used to determine the relevance score for a business category.

In some aspects, the term frequency for a category phrase will equal the number of occurrences of the category phrase across all documents related to a particular business. By way of example, if the subject business entity is “Lang's Cafe” and the business category is “Diner”, the term frequency for a category phrase (associated with the “Diner” category) will be based on the number of times the category phrase occurs within the business related documents pertaining to “Lang's Café.”

The global frequency for a category phrase may be determined based on the number of occurrences of the category phrase within all business related documents. Using the above example, the global frequency of a category phrase associated with the “Diner” category is determined based on the number of occurrences of the category phrase within all available business related documents.

In some examples, the document frequency of a category phrase (with respect to a particular business) is defined as the number of business related documents that contain the category phrase. Using the above example, the document frequency of a category phrase for the “Diner” category would be based on the number of business related documents that contain the category phrase.

In certain aspects, the web reference count is equal to the total number of business related documents related to a particular business. For example, the web reference count for “Lang's Café” would be based on the number of business related documents containing information related to “Lang's Café.”

In some implementations, the quotient of the term frequency and global frequency can be used as an indicator for the relevance of the category phrase with respect to a particular business entity. In another example, the quotient of the document frequency and the web reference count can give another measure of the relevance of a particular category phrase with respect to the business entity. By calculating the term frequency, global frequency and document frequency for each category phrase in a given business category, as well as a web reference count, the relevance score for the category can be determined.

The relevance score (RS) is determined from the term frequency (TF), global frequency (GF), document frequency (DF) and web reference count (WR) for a particular business category. In some examples, the relevance score for a particular category phrase X, with respect to a particular business entity B is given by:

RS(X,B)=(TF(X,B)/GF(X))̂I*(DF(X,B)/WR(B))̂J;

Depending on implementation, the weighting parameters ‘I’ and ‘J’ can be used to tune the classification. It is understood that the weighting parameters could vary for a number of reasons, including but not limited to difference between languages, business type, location, or the composition of available documents, etc. Although the weighting parameters could have any numerical value, in some examples the value of ‘I’ and ‘J’ could vary between 2 and 2.5.

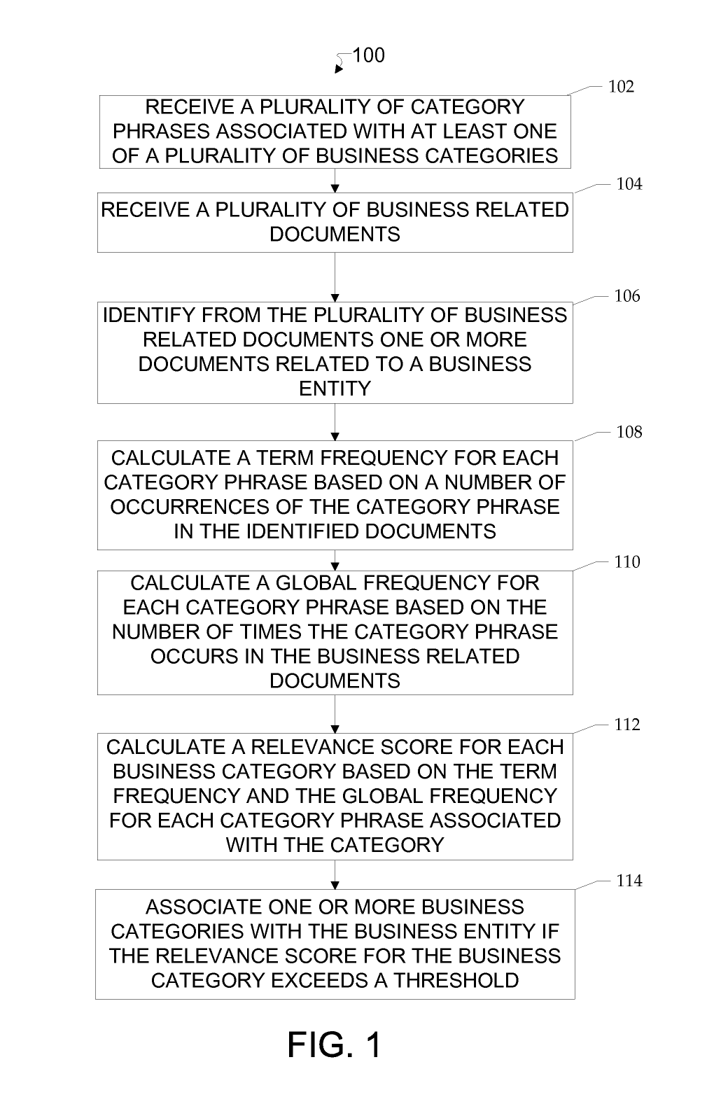

FIG. 1 illustrates a flow diagram of an example method 100 for associating one or more business categories with a business entity. As illustrated, the method 100 begins with step 102 in which a plurality of category phrases associated with at least one of a plurality of business categories are received. It should be understood that category phrases could comprise essentially any information item related to a business category; however, in some examples each category phrase will comprise one or more keywords. In some examples, the relationship between the category phrases and the business categories will be predetermined. Furthermore, it should be understood that the received category phrases can be associated with one or more business category; for example, the plurality of phrases could be associated with a single category, or with multiple categories. Thus, category phrases are not exclusively associated with any particular business category.

In step 104, a plurality of business related documents are received. The received business related documents can comprise essentially any electronic information or documents related to one or more businesses. For example, the business related documents could comprise, but are not limited to: web pages, business reviews, anchor text, search queries, web addresses, etc. that contain information related to one or more businesses. In some examples, the business related information can be listing information such as business name, address and operating hours information. However, business related documents could contain essentially any type of information related to businesses including product and/or service reviews, menu items, advertising and/or marketing information, etc.

In step 106, one or more business documents related to a business entity are identified from the plurality of business related documents. By way of the above example, if the subject business entity was “Lang's Café” the one or more identified business related documents would comprise any of the received business documents containing information relating to “Lang's Café.”

In step 108, a term frequency for each category phrase is calculated. The term frequency is based on a number of occurrences of the category phrase in the identified documents. As discussed above, the term frequency for a category phrase gives a measure of the frequency of the category phrase within the body of documents that reference a particular business entity.

In step 110, a global frequency is calculated for each category phrase based on the number of times the category phrase occurs in the business related documents. Thus, the global frequency measures the frequency of a category phrase within all business related documents (i.e., the corpus of all available electronic documents containing business related information).

In step 112, a relevance score for each business category is calculated based on the term frequency and the global frequency for each category phrase associated with the category. As discussed above, the relevance score indicates the relevance of a business category to a particular business entity, based on the category phrases that are associated with that business category. Although the relevance score can comprise essentially any numerical value, as will be discussed in further detail below, in some implementations the relevance score can comprise a multi-dimensional number.

The relevance score could be calculated as a quotient of the term frequency and the global frequency. For example, one measure of relevance between a category phrase and a business entity could be given by the relationship:

R1(X,B)=TF(X,B)/GF(X);

wherein, X is a category phrase for a business entity B.

In another implementation, the relevance score could be a function of document frequency and web reference count. In one example, the relevance score can be measured as a quotient of the document frequency and web reference count. As discussed above, the document frequency for a given category phrase (with respect to a particular business) is defined as the number of business related documents that contain the category phrase. The web reference count is defined as the total number of business related documents related to a particular business. For example, a second measure of relevance between a category phrase and a business entity could be given by the relationship:

R2(X,B)=DF(X,B)/WR(B);

wherein, X is a category phrase for a business entity B.

A relevance score can be calculated that is based on the term frequency, the global frequency, the document frequency and the web reference count. For example, a relevance score for a particular business category (relative to a business entity) could be calculated as a product of the relevance scores given above. In some examples, a relevance score is given by the relationship:

RS(X,B)=(TF(X,B)/GF(X))̂I*(DF(X,B)/WR(B))̂J;

where ‘X’ is a category phrase associated with a particular business entity ‘B’ and ‘I’ and ‘J’ weighting factors.

The values of ‘I’ and ‘J’ can be chosen to affect the classification. As discussed above, the weighting parameters ‘I’ and ‘J’ can vary depending on implementation; however, in some examples the value of ‘I’ and ‘J’ may vary between about 2 and 2.5. In certain aspects, parameter values for parameters ‘I’ and ‘J’ may be chosen and/or tuned based on an analysis of classification performance for businesses in which correct categories are already known.

In step, 114 one or more business categories are associated with the business entity if the relevance score for the business category exceeds a threshold. In some examples, the threshold relevance score could indicate a minimum relevance between a business category and a business entity that would be required for the association of the category with the business entity. In another aspect, multiple business categories can be associated with the business entity based the relevance scores of each of the multiple business categories.

The association of one or more of a plurality of business categories with the business entity can be based on the relative relevance scores calculated for each of the one or more of the plurality of business categories (e.g., a highest score). However, it is understood that the process of associating any business category with a business entity can be based on a variety of metrics and is not necessarily based on a predetermined threshold or highest score.

In one implementation, the process of associating a business category with a particular business entity could be performed using a machine-learning method. For example, the association between a business category and a business entity could be performed based on the multidimensional category score of the business category, using a machine-learning classification method.

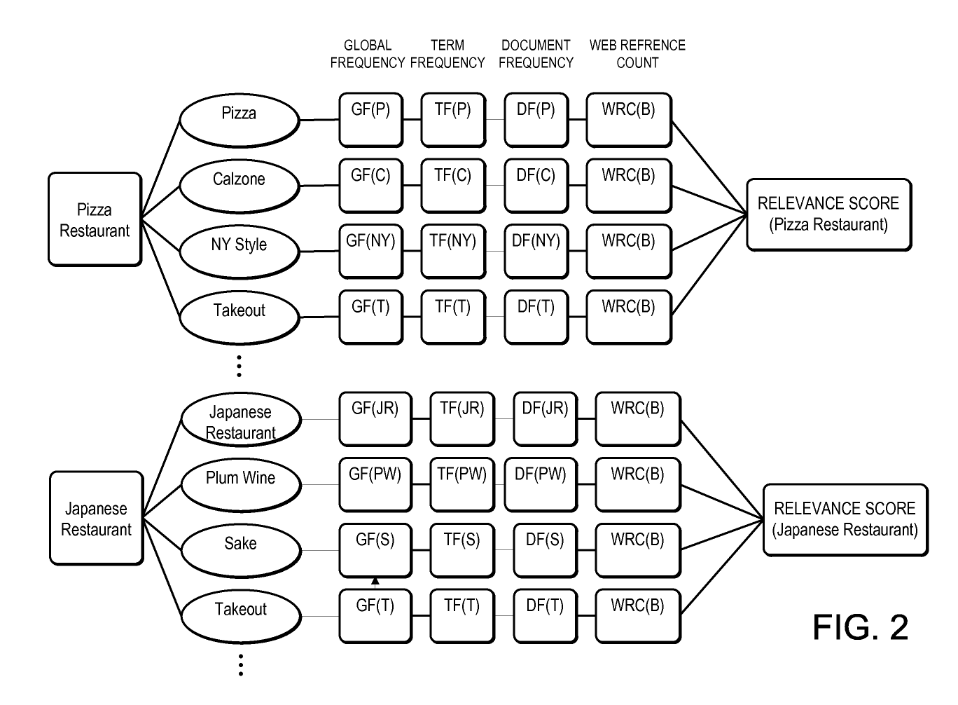

FIG. 2 conceptually illustrates an example of the relationship between a business category and a relevance score, according to some aspects of the subject disclosure. Specifically, FIG. 2 illustrates the conceptual relationship between a business category, associated category phrases and the relevance score.

As illustrated, FIG. 2 depicts two restaurant related business categories, a “Pizza Restaurant” category and a “Japanese Restaurant” category. Further illustrated in FIG. 2 are category phrases associated with each of the depicted business categories. As shown, the Pizza Restaurant category is associated with the category phrases “Pizza,” “Calzone,” “NY Style” and “Takeout.” The Japanese Restaurant category is associated with the category phrases “Japanese Restaurant,” “Plum Wine,” “Sake” and “Takeout.” It is understood that although two business categories are illustrated in FIG. 2, essentially any number of business categories could be used, depending on the desired implementation.

In the example illustrated in FIG. 2, each of the business categories are associated with four category phrases; however it is understood that any number of category phrases could be associated with a particular business category and that the category phrases can comprise single or multiple words, abbreviations and/or other types of descriptors, etc. Furthermore, it is understood that any particular category phrase can be associated with one or more business category. For example, in the illustration of FIG. 2, the category phrase “Takeout” is associated with both the “Pizza Restaurant” category and the “Japanese Restaurant” category.

The diagram of FIG. 2 also conceptually illustrates the relationship between category phrases and corresponding relevance scores, as well as the intervening calculations for the global frequency, term frequency, document frequency and web reference count. For example, with respect to the “Pizza Restaurant” category, the category phrase “Pizza” has a global frequency, represented as GF(P), a term frequency of TF(P), a document frequency of DF(P) and a web reference count of WRC(B). As discussed above, each of the calculations (e.g., global frequency, term frequency, document frequency and web reference count) for each of the category phrases can contribute to the relevance score of a particular business category, for example, Relevance Score for the “Pizza Restaurant” category. In determining whether to associate the “Pizza Restaurant” category or the “Japanese Restaurant” category with a business entity ‘B’, the above calculations may be performed for each of the category phrases. As illustrated, the relevance scores for a particular business category can be based on the category phrases associated with the business category.

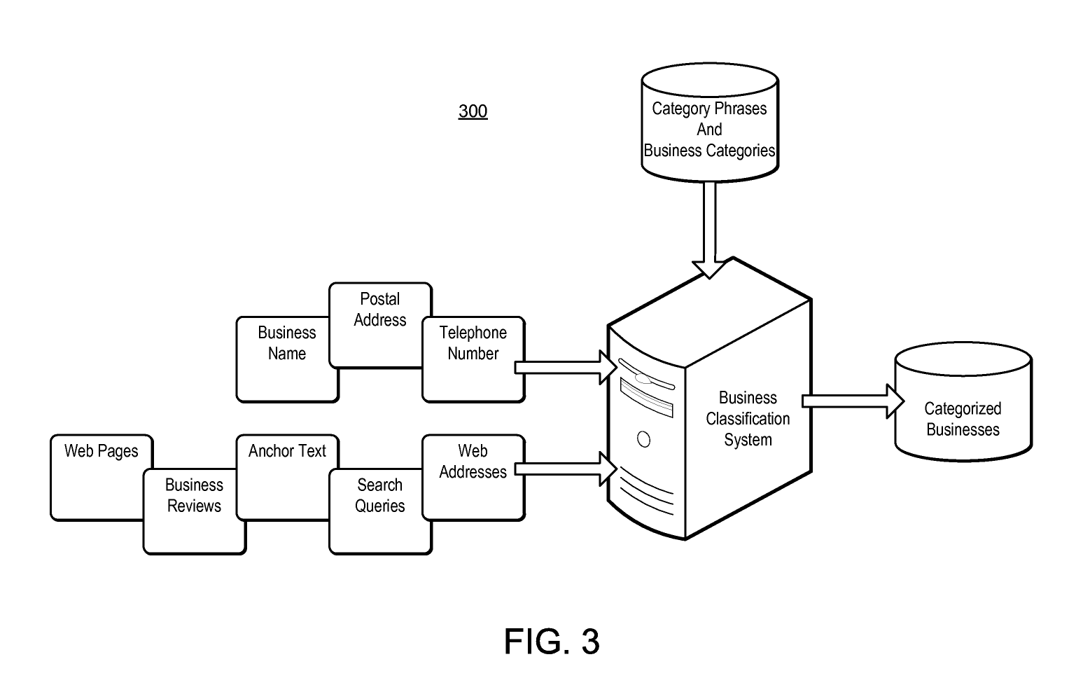

FIG. 3 conceptually illustrates an example of a Business Classification system 300 that receives web documents, as well as category phrases and Business Categories for use in producing categorized business information. In some examples, Business Classification System 300 can receive a plurality of business related documents related to one or more businesses. However, in other examples, Business Classification System 300 may identify a corpus of business related documents from among a plurality of electronic data items.

In some implementations, electronic data items received by Business Classification System 300 could comprise essentially any type of information content, including but not limited to: web pages, online reviews, anchor text, social media streams, etc. Furthermore, in some examples, business related documents could be identified from among the electronic data items through the identification of information related to one or more businesses. Although the information related to one or more businesses can comprise essentially any type of information, in some implementations the information could comprise one or more of a business name, business postal address, business telephone number, etc.

Additionally, in some aspects Business Classification System 300 can receive the category phrases and business category associations. As discussed above, the category phrases associated with the business categories may be predetermined; however, in some embodiments the associations between category phrases and business categories could be determined by Business Classification System 300 and/or by one or more other or additional processor based systems.

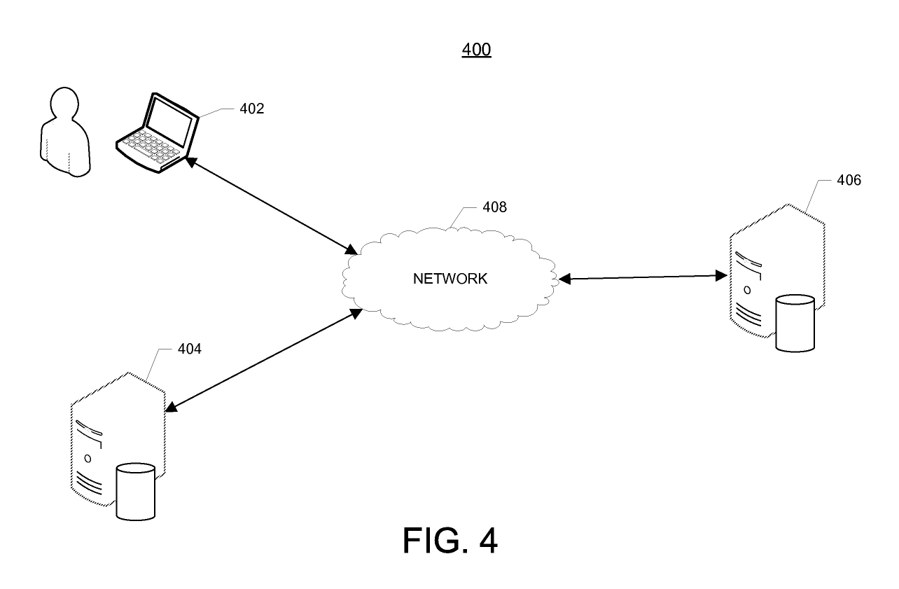

FIG. 4 conceptually illustrates one example of a network system 400 in which some aspects of the subject technology may be implemented. Specifically, network system 400 comprises user device 402, first server 404, second server 406 and network 408. As illustrated, user device 402, first server 404 and second server 406 are communicatively connected via network 408. It is understood that in addition to user device 402, first server 404 and second server 406, any number of other processor-based devices may be communicatively connected to network 408. Furthermore, as will be discussed in greater detail below, network 408 could comprise multiple networks, such as a network of networks, e.g., the Internet.

Depending on the desired implementation, one or more of the process steps of the subject technology can be carried out by one or more of user device 402, first server 404 and second server 406, over network 408. By way of example, first server 404 could receive, via network 408, a plurality of category phrases associated with at least one of a plurality of business categories from second server 406 and/or user device 402. First server 404 could also receive, via network 408, a plurality of business related documents from second server 406/and or user device 402. Subsequently, first server 404 could be configured to implement the process steps of the subject technology, for example, the first server could perform steps for identifying, from a plurality of business related documents, one or more documents related to the business entity, calculating a term frequency for each of a plurality of category phrases, wherein each of the plurality of category phrases is associated with at least one of a plurality of business categories, wherein the term frequency for each of the category phrases is based on a number of occurrences of the category phrase within the one or more identified documents. First server 404 could further be configured to calculate a global frequency for each of the plurality of category phrases, wherein the global frequency for each of the category phrases is based on a number of occurrences of the category phrase within the plurality of business related documents, and for calculating a relevance score for each of the plurality of business categories, wherein the relevance score for each business category is based on the term frequency and the global frequency for each of the category phrases associated with that business category. In certain implementations, first server 404 may be further configured to associate one or more of the plurality of business categories with the business entity based on the relevance score calculated for each of the one or more of the plurality of business categories.

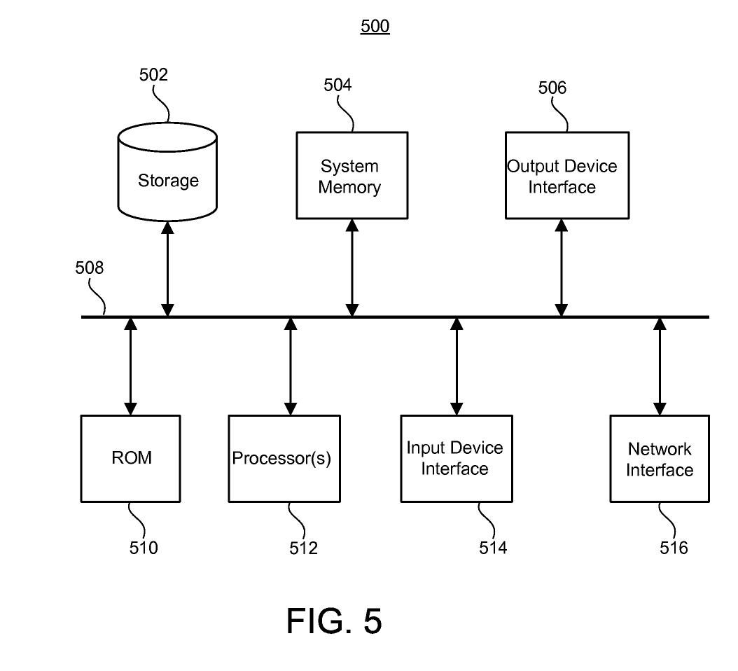

FIG. 5 illustrates an example of an electronic system that can be used for executing the steps of the subject disclosure. In some examples, electronic system 500 can be a single computing device such as a server (e.g., first server 404 and/or second server 406, discussed above). Furthermore, in some implementations, electronic system 500 can be operated alone or together with one or more other electronic systems e.g., as part of a cluster or a network of computers.

As illustrated, the processor-based system 500 comprises storage 502, system memory 504, output device interface 506, system bus 508, ROM 510, one or more processor(s) 512, input device interface 514 and network interface 516. In some aspects, system bus 508 collectively represents all system, peripheral, and chipset buses that communicatively connect the numerous internal devices of processor-based system 500. For instance, system bus 508 communicatively connects processor(s) 512 with ROM 510, system memory 504, output device interface 506 and permanent storage device 502.

In some implementations, the various memory units, processor(s) 512 retrieve instructions to execute (and data to process) in order to execute the steps of the subject disclosure. Processor(s) 512 can be a single processor or a multi-core processor in different implementations. Additionally, processor(s) 512 may comprise one or more graphics processing units (GPUs) and/or one or more decoders, depending on implementation.

ROM 510 stores static data and instructions that are needed by processor(s) 512 and other modules of processor-based system 500. Similarly, processor(s) 512 can comprise one or more memory locations such as a CPU cache or processor in memory (PIM), etc. Storage device 502 is a read-and-write memory device. In some aspects, this device can be a non-volatile memory unit that stores instructions and data even when processor-based system 500 is without power. Some implementations of the subject disclosure can use a mass-storage device (such as solid state, magnetic or optical storage devices) e.g., permanent storage device 502.

Other implementations can use one or more a removable storage devices (e.g., magnetic or solid state drives) such as permanent storage device 502. Although the system memory can be either volatile or non-volatile, in some examples system memory 504 is a volatile read-and-write memory, such as a random access memory. System memory 504 can store some of the instructions and data that the processor needs at runtime.

In some implementations, the processes of the subject disclosure are stored in system memory 504, permanent storage device 502, ROM 510 and/or one or more memory locations embedded with processor(s) 512. From these various memory units, processor(s) 512 retrieve instructions to execute and data to process in order to execute the processes of some implementations of the instant disclosure.

Bus 508 also connects to input device interface 514 and output device interface 506. Input device interface 514 enables a user to communicate information and select commands to processor-based system 500. Input devices used with input device interface 514 may include for example, alphanumeric keyboards and pointing devices (also called “cursor control devices”) and/or wireless devices such as wireless keyboards, wireless pointing devices, etc.

Finally, as shown in FIG. 5, bus 508 also communicatively couples processor-based system 500 to a network (not shown) through network interface 516. It should be understood that network interface 516 can be either wired, optical or wireless and may comprise one or more antennas and transceivers. In this manner, processor-based system 500 can be a part of a network of computers, such as a local area network (“LAN”), a wide area network (“WAN”), or a network of networks, such as the Internet (e.g., network 408, as discussed above).

In practice some aspects of the subject technology can be carried out by processor-based system 500. In some aspects, instructions for performing one or more of the method steps of the present disclosure will be stored on one or more memory devices such as storage 502 and/or system memory 504. Furthermore, system 500 may be used for receiving information from a plurality of social network users. In some aspects, business related documents and/or category phrases associated with one or more business categories can be received by system 500 (e.g., via input device interface 514 and/or network interface 516).

In some examples, the received business related documents and/or category phrases associated with one or more business categories could be used to associate one or more business categories with a business entity. In some implementations, the processing and/or parsing of the post information to associate one or more business categories with a business entity can be performed using the one or more processors such as the processor(s) 512 of system 500. Additionally, any results can be transmitted (either immediately or from a memory device) to another system, display device, network device and/or computer via output device interface 506 and/or the network interface 516 for transmission to a network, such as network 408, described above.

In this specification, the term “software” is meant to include firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of exemplary approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

It is understood that the specific order or hierarchy of steps disclosed herein is exemplify some implementations of the subject technology. However, depending on design preference, it is understood that the specific order or hierarchy of steps in the processes can be rearranged. For example, some of the steps may be performed simultaneously. As such, the accompanying method claims present elements of the various steps in a sample order, and are not meant to be limited to the specific order or hierarchy presented.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims.

1. A computer-implemented method for assigning a category to a business entity, the method comprising;
identifying, by one or more computing devices, one or more documents related to a business entity from a plurality of business related documents;
calculating, by the one or more computing devices, a term frequency for each of a plurality of category phrases, wherein each of the plurality of category phrases is associated with at least one of a plurality of business categories, and wherein the term frequency for each of the category phrases is based on a number of occurrences of the category phrase within the one or more identified documents;
calculating, by the one or more computing, devices, a document frequency for each of the plurality of category phrases based on a number of the one or more identified documents that include the category phrase;
calculating, by the one or more computing devices, a global frequency for each of the plurality of category phrases, wherein the global frequency for each of the category phrases is based on a number of occurrences of the category phrase within, the plurality of business related documents;
calculating, by the one or more computing devices, a web reference count associated with the business entity, Wherein the web reference count is based on a total number of the one or more identified documents related to the business entity;
calculating, by the one or more computing devices, a relevance score for each of the plurality of business categories, the relevance score providing a measure of relevance between the business entity and each business category wherein the relevance score for each business category is based on the term frequency, the document frequency, the global frequency and the web reference count; and
associating, by the one or more computing devices, one or more of the plurality of business categories with the business entity based on the relevance score calculated for each of the one or more of the plurality of business categories.

2. (canceled)

3. The method of claim 1, wherein the one or more documents are related to the business entity if the one or more documents include information about the business entity, including at least one of a name of the business entity, a postal address of the business entity, a telephone number of the business entity, or a computer network address of the business entity.

4. The method of claim 1, wherein the step of identifying the one or more documents related to the business entity, further comprises:
receiving the plurality of business related documents, wherein each of the plurality of business related documents comprises information related to one or more businesses.

5. The method of claim 1, further comprising:
receiving each of the plurality of category phrases associated with the at least one of the plurality of business categories.

6. The method of claim 3, further comprising:
associating the one or more of the plurality of business categories with the business entity if the relevance score for the business category exceeds a threshold.

7. A system for assigning a category to a business entity, the system comprising:
one or more processors; and
a non-transitory machine-readable medium comprising instructions stored therein, which when executed by the one or more processors, cause the one or more processors to perform operations comprising:
identifying, from a plurality of business related documents, one or more documents related to a business entity;
calculating a term frequency for each of a plurality of category phrases, wherein each of the plurality of category phrases is associated with at least one of a plurality of business categories, and wherein the term frequency for each of the category phrases is based on a number of occurrences of the category phrase within the one or more identified documents;
calculating a global frequency for each of the plurality of category phrases, wherein the global frequency for each of the category phrases is based on a number of occurrences of the category phrase within the plurality of business related documents;
calculating a document frequency for each of the plurality of category phrases based on a number of the one or more identified documents that include the category phrase;
Calculating a web reference count associated with the business entity wherein the web reference count is based on a total number of the one or more identified documents related to the business entity;
calculating a relevance score for each of the plurality of business categories, the relevance score providing a measure of relevance between the business entity and each business category, wherein the relevance score for each business category is based on the term frequency, the global frequency and the document frequency for each of the category phrases associated with that business category; and
associating one or more of the plurality of business categories with the business entity based on the relevance score calculated for each of the one or more of the plurality of business categories.

8. (canceled)

9. The system of claim 7, wherein the one or more documents are related to the business entity if the one or more documents include information about the business entity, including at least one of a name of the business entity, a postal address of the business entity, a telephone number of the business entity, or a computer network address of the business entity.

10. The system of claim 7, wherein the step of identifying the one or more documents related to the business entity, further comprises:
receiving the plurality of business related documents, wherein each of the plurality of business related documents comprises information related to one or more businesses.

11. The system of claim 7, further comprising;
receiving each of the plurality of category phrases associated with the at least one of the plurality of business categories.

12. The system of claim 7S further comprising:
associating the one or more of the plurality of business categories with the business entity if the relevance score for the business category exceeds a threshold.

13. A non-transitory machine-readable medium comprising instructions stored therein, which when executed by a machine, cause the machine to perform operations comprising:
identifying, from a plurality of business related documents, one or more documents related to a business entity;
calculating a term frequency for each of a plurality of category phrases, wherein each of the plurality of category phrases is associated, with at least one of a plurality of business categories, and wherein the term frequency for each of the category phrases is based on a number of occurrences of the category phrase within the one or more identified documents;
calculating a global frequency for each of the plurality of category phrases, wherein the global frequency for each of the category phrases is based on a number of occurrences of the category phrase within the plurality of business related documents;
calculating a document frequency for each of the plurality of category phrases based on a number of the one or more identified documents that include the category phrase;
calculating a web reference count based on a total number of the one or more identified documents related to the business entity;
calculating a relevance score for each of the plurality of business categories, the relevance score providing a measure of relevance between the business entity and each business category, wherein the relevance score for each business category is based on the term frequency, the global frequency, the document frequency and the web reference count; and
associating one or more of the plurality of business categories with the business entity based on the relevance score calculated for each of the one or more of the plurality of business categories.

14. The machine-readable medium of claim 13, wherein the one or more documents are related to the business entity if the one or more documents include information about the business entity, including at least one of a name of the business entity, a postal address of the business entity, a telephone number of the business entity, or a computer network address of the business entity.

15. The machine-readable medium of claim 13, wherein the step of identifying the one or more documents related to the business entity, further comprises:
receiving the plurality of business related documents, wherein each of the plurality of business related documents comprises information related to one or more businesses.

16. The machine-readable medium of claim 13, further comprising;
receiving each of the plurality of category phrases associated with the at least one of the plurality of business categories.

17. The machine-readable medium of claim 13, further comprising:
associating the one or more of the plurality of business categories with the business entity if the relevance score for the business category exceeds a threshold.

18. The machine-readable medium of claim 13, wherein the relevance score calculated for each of the one or more of the plurality of business categories comprises a multi-dimensional number.

19. The method of claim 1, further comprising providing, by the one or more computing devices, search results based on the determined association between the one or more of the plurality of business categories and the business entity.

20. The system of claim 7, wherein the operations further comprise providing search results based on the determined association between the one or more of the plurality of business categories and the business entity.

21. The machine-readable medium of claim 13, wherein the operations further comprise providing search results based on the determined association between the one or more of the plurality of business categories and the business entity.
